(19) United States
(12) Patent Application Publication
(10) Pub. No.: US 2025/0178928 A1
(43) Pub. Date: Jun. 5, 2025

(54) UNMANNED SURFACE VEHICLE (USV) FOR TREATING BODIES OF WATER AND WATER-CARRYING PIPELINES

(71) Applicant: Ohio State Innovation Foundation, Columbus, OH (US)

(72) Inventors: Jiyoung LEE, Grandview Heights, OH (US); Kendall BYRD, Columbus, OH (US)

(21) Appl. No.: 18/840,594

(22) PCT Filed: Mar. 2, 2023
(86) PCT No.: PCT/US2023/063556

§ 371 Date: Aug. 22, 2024

Related U.S. Application Data
(60) Provisional application No. 63/316,663, filed on Mar. 4, 2022.

(51) Int. Cl. C02F 1/32; B63B 35/00; C02F 103/00

(52) U.S. Cl. CPC C02F 1/325; B63B 35/00; B63B 2035/007; C02F 2103/007; C02F 2201/008; C02F 2201/009; C02F 2201/3227; C02F 2201/3228; C02F 2209/36; C02F 2303/04

(57) ABSTRACT

An unmanned surface vehicle (CSV) includes a. frame assembly, one or more motors coupled to the frame assembly, one or more float tubes coupled to the frame assembly to provide buoyancy, a plurality of ultraviolet-C (UV-C) lights, a controller configured to operate the one or more motors to cause the US V to maneuver on or near the surface of the body of water and to selectively activate the plurality of UV-C lights to inactivate pathogens in the body of, and a power supply to provide electrical power to the one or more motors, the plurality of UV-C lights and the controller.

### CROSS-REFERENCE TO RELATED APPLICATIONS

This application claims the benefit of and priority to U.S. Provisional Patent App. No. 63/316,663, filed Mar. 4, 2022, which is incorporated herein by reference in its entirety.

### BACKGROUND

Freshwater resources around the world are under stress due to naturally occurring events and human impacts. These circumstances have caused an increase in Cyanobacteria blooms, also known as harmful algal blooms (HABs). Not only has an increase in frequency of blooms been observed, but an increase in bloom duration and geographical location is also occurring. During these blooms, Cyanobacteria can release harmful toxins known as cyanotoxins.

Water treatment plants commonly produce large amounts of waste referred to as “sludge,” which is often temporarily stored in a lagoon before being disposed into a landfill. These waste lagoons are one such environment in which HABs and cyanotoxins are becoming more intensified. Additionally, the use of sludge as a fertilizer and soil conditioner for agricultural land is gaining popularity. However, if this sludge is applied to agricultural land without proper treatment, toxic Cyanobacteria can grow in the soil and produce toxins, which can remain in the soil and be taken up by plants. Further, HABs can greatly increase drinking water treatment costs to remove the toxins. For example, HABs increased the cost of drinking water treatment by about $13 million in Ohio from 2011-2012.

In addition, many other known pathogens (e.g., E. coli, Salmonella, Campylobacter, Legionella, Pseudomonas, etc.) can affect bodies of water and water-carrying pipelines, posing potential risks for humans. For example, swimming pools are often treated with harsh chemicals (e.g., chlorine) to prevent or treat bacteria. Yet, consumers and manufacturers are often left with few options for treatment, despite increasing concern in the side-effects of chemical usage (e.g., carcinogenic disinfection byproducts) and growing interest in safe and environmentally-friendly alternatives to chemical treatments.

### SUMMARY

One implementation of the present disclosure is an unmanned surface vehicle (USV) for treating pathogens in a body of water. The USV includes a frame assembly; one or more motors coupled to the frame assembly, each of the one or more motors configured to drive a corresponding propeller; one or more float tubes coupled to the frame assembly, where the one or more float tubes provide buoyancy such that the USV is configured to sit on or near a surface of the body of water; a plurality of ultraviolet-C (UV-C) lights; a controller configured to operate the one or more motors to cause the USV to maneuver on or near the surface of the body of water and to selectively activate the plurality of UV-C lights to inactivate pathogens in the body of water; and a power supply to provide electrical power to the one or more motors, the plurality of UV-C lights and the controller.

In some implementations, the USV further includes one or more hollow UV-C tubes coupled to the frame assembly, wherein the plurality of UV-C lights are mounted to an interior surface of the one or more hollow UV-C tubes such that the plurality of UV-C lights are configured to emit radiation inward from the interior surface of the one or more hollow UV-C tubes.

In some implementations, each of the one or more hollow UV-C tubes is defined by a first end and a second end, wherein at least the first end includes a screen or mesh.

In some implementations, the one or more hollow UV-C tubes includes at least two hollow UV-C tubes.

In some implementations, the interior surface of the one or more hollow UV-C tubes is coated in titanium dioxide (TiO₂).

In some implementations, the interior surface of the one or more hollow UV-C tubes includes a nanoparticle coating of titanium dioxide (TiO₂).

In some implementations, the frame assembly includes a top frame portion, a bottom frame portion, and one or more supports that couple the top frame portion and the bottom frame portion.

In some implementations, the plurality of UV-C lights are positioned on at least one side of the top frame portion of the frame assembly and configured to emit radiation to at least one side of the USV.

In some implementations, a subset of the plurality of UV-C lights are positioned on at least one side of the bottom frame portion of the frame assembly.

In some implementations, the USV further includes a bottom panel coupled to the bottom frame portion of the frame assembly, wherein a subset of the plurality of UV-C lights are coupled to the bottom panel and configured to emit radiation downward from a bottom of the USV.

In some implementations, the USV further includes a hydroelectric turbine coupled to the frame assembly, wherein the hydroelectric turbine generates electricity due to movement of water as the USV to maneuvers on or near the surface of the body of water.

In some implementations, the hydroelectric turbine includes: a generator including a shaft; a plurality of arms coupled to and extending from the shaft; and a plurality of paddles or cups, wherein each of the plurality of paddles or cups is coupled to a respective one of the plurality of arms.

In some implementations, the power supply includes a rechargeable battery that is configured to be at least partially recharged by the hydroelectric turbine as the USV to maneuvers on or near the surface of the body of water.

In some implementations, the controller includes a wireless communications interface for wirelessly communicating data with a remote device.

In some implementations, the remote device is one of a smartphone, a laptop computer, or a remote control for operating the USV.

In some implementations, the one or more motors includes at least two motors having corresponding propellers.

In some implementations, the one or more float tubes include at least two float tubes.

In some implementations, the controller and the power supply are contained within a waterproof housing.

In some implementations, the USV further includes one or more sensors for monitoring water quality.

In some implementations, the one or more sensors are configured to detect pathogens in the body of water, wherein the controller is configured to automatically activate the plurality of UV-C lights if a level or amount of the detected pathogens exceeds a threshold.

In some implementations, the USV further includes at least one of a gyroscope, an accelerometer, and a magnetometer.

In some implementations, the plurality of UV-C lights are UV-C light emitting diodes (LEDs).

In some implementations, the pathogens include cyanobacteria.

Another implementation of the present disclosure is an unmanned surface vehicle (USV) for treating pathogens in a body of water, the USV including: a body including a shell and two parallel hull portions that extend downward from the shell, wherein the two parallel hull portions provide buoyancy such that the USV is configured to sit on or near a surface of the body of water; one or more motors coupled to the frame assembly, each of the one or more motors configured to drive a corresponding propeller; a plurality of ultraviolet-C (UV-C) lights; a controller configured to operate the one or more motors to cause the USV to maneuver on or near the surface of the body of water and to selectively activate the plurality of UV-C lights to inactivate pathogens in the body of water; and a power supply to provide electrical power to the one or more motors, the plurality of UV-C lights, and the controller.

In some implementations, the two parallel hull portions are integrally formed with the shell to form the body of the USV.

In some implementations, the shell is defined by a top side and a bottom side, and wherein each of the two parallel hull portions are defined by an outer-facing side and an inner-facing side.

In some implementations, at least a portion of the plurality of UV-C lights are positioned on the bottom side of the shell to emit radiation downwards from the bottom side of the shell.

In some implementations, at least a portion of the plurality of UV-C lights are positioned on the inner-facing sides of the two parallel hull portions to emit radiation inwards.

In some implementations, the bottom side of the shell and the inner-facing sides of the two parallel hull portions define an open space below the shell of the USV.

In some implementations, the plurality of UV-C lights are positioned on the bottom side of the shell and on the inner-facing sides of the two parallel hull portions to emit radiation downwards and inwards into the open space.

In some implementations, the USV further includes a panel coupled to a bottom of, and extending between, the two parallel hull portions, wherein at least a portion of the plurality of UV-C lights are coupled to a top surface of the panel and configured to emit radiation upward into the open space.

In some implementations, at least one of the bottom side of the shell or the inner-facing sides of the two parallel hull portions are coated in titanium dioxide (TiO₂).

In some implementations, the USV further includes a screen or mesh that extends across a front of the USV.

In some implementations, the screen or mesh extends between the two parallel hull portions.

In some implementations, the USV further includes a hydroelectric turbine coupled to the frame assembly, wherein the hydroelectric turbine generates electricity due to movement of water as the USV to maneuvers on or near the surface of the body of water.

In some implementations, the hydroelectric turbine includes: a generator including a shaft; a plurality of arms coupled to and extending from the shaft; and a plurality of paddles or cups, wherein each of the plurality of paddles or cups is coupled to a respective one of the plurality of arms.

In some implementations, the power supply includes a rechargeable battery that is configured to be at least partially recharged by the hydroelectric turbine as the USV to maneuvers on or near the surface of the body of water.

In some implementations, the controller includes a wireless communications interface for wirelessly communicating data with a remote device.

In some implementations, the remote device is one of a smartphone, a laptop computer, or a remote control for operating the USV.

In some implementations, the one or more motors includes at least two motors having corresponding propellers.

In some implementations, the controller and the power supply are contained within a waterproof housing.

In some implementations, the USV further includes one or more sensors for monitoring water quality.

In some implementations, the one or more sensors are configured to detect pathogens in the body of water, wherein the controller is configured to automatically activate the plurality of UV-C lights if a level or amount of the detected pathogens exceeds a threshold.

In some implementations, the USV further includes at least one of a gyroscope, an accelerometer, and a magnetometer.

In some implementations, the plurality of UV-C lights are UV-C light emitting diodes (LEDs).

In some implementations, the pathogens include Cyanobacteria.

Additional features will be set forth in part in the description which follows or may be learned by practice. Various features described herein will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

FIGS. 1A-1C are diagrams showing one configuration of an unmanned surface vehicle (USV) for water treatment from various different perspectives, according to some implementations.

FIGS. 2A-2C are diagrams showing an alternate configuration of the USV from various different perspectives, according to some implementations.

FIGS. 3A and 3B are diagrams showing yet another alternate configuration of the USV from various different perspectives, according to some implementations.

FIG. 4 is a diagram of a control system for the USV described herein, according to some implementations.

FIGS. 5-7 are diagrams illustrating prototype configuration of the USV of FIGS. 1A-1C, according to some implementations.

FIG. 8 is a diagram of an example remote control for the USV described herein, according to some implementations.

FIGS. 9A and 9B are diagrams of an example UV-C tube containing an array of UV-C lights, according to some implementations.

FIGS. 10A and 10B are diagrams of an example hydroelectric turbine for use with the USV described herein, according to some implementations.

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

### DETAILED DESCRIPTION

Referring generally to the figures, an unmanned surface vehicles (USV) for treating bodies of water and water-carrying pipelines, such as water treatment holding pools (“lagoons”) and inlet pipes, is shown, according to various implementations. The USV described herein generally includes a plurality of UV-C lights for neutralizing pathogens, such as Cyanobacteria due to HABs, which in turn can prevent the release of harmful toxins (e.g., cyanotoxins). Notably, the USV described herein may be compact and more environmentally friendly than many other wastewater treatment methods. For example, the USV may treat wastewater without the use of chemicals, so there will be little to no chemical by-products produced during treatment. Additionally, the USV is cost-effective; once manufactured, additional costs are minimized to regular maintenance and the energy required to operate the UV-C lights.

The USV described herein can also be used for on-site treatment; for example, by treating HABs at the source—e.g., water lagoons and inlet pipes—before it can contaminate other environments. Due to the USV's compact size, it may be easily transportable, making it useful for treating multiple locations. Accordingly, the USV may readily treat HABs by neutralizing Cyanobacteria in water lagoons and areas around water intake pipes, such that the stored sludge can be safely disposed of onto agricultural fields or into landfills, which further benefits local environments and agricultural users. In addition, it will be appreciated that the USV can treat water contaminated with other pathogens (e.g., toxic E. coli) in a similar manner to the treatment of Cyanobacteria. To that point, “pathogens”—as used herein—generally refers to any disease-causing water-borne organisms, such as bacteria, Cyanobacteria, E. coli, Salmonella, viruses, Cryptosporidium, and the like, as described in greater detail below. Additional features and advantages of said USV are described in greater detail below

### Cyanobacteria and Other Pathogens

As referenced throughout this disclosure, Cyanobacteria are a type of photosynthetic bacteria. Some types Cyanobacteria (e.g., Microcystis, which is a genus of freshwater Cyanobacteria) can form HABs in eutrophic waterbodies. Microcystin is one of the most common toxins produced by Microcystis and other Cyanobacteria, which can be harmful to humans and animals can accumulate in fish, other seafood, and fresh produce. Microcystin is a stable compound due to its cyclic peptide structure. As such, boiling does not degrade it but instead actually concentrates the toxin. Bacteriophages (phages), also mentioned herein, are viruses that exclusively infect bacteria. Cyanophage, in particular, are viruses that exclusively infect Cyanobacteria.

As described in greater detail below, the USV described herein generally utilizes UV light to treat pathogens such as Cyanobacteria. UV irradiation induces linkages between adjacent nucleotides to alter the double helix structure of DNA, which interrupts the normal process of DNA replication and thereby interferes with bacterial reproductive capacity. In addition, suppression of gene expression could disturb the repair process of molecules damaged by UV. The essential part of phototrophic microorganisms, photosynthesis, is also severely damaged by UV stress. In some cases, UV irradiation can collapse gas vesicles of Microcystis, which deteriorates their ability of buoyancy to find the best/optimal vertical location in the water and floating ability in the photic zone in the water column. Additionally, UV irradiation can lead to the increase of reactive oxygen species (ROS) and accelerate oxidative stress to the bacteria.

Cyanophages, as mentioned above, are viruses that infect Cyanobacteria as their host, which is host-specific (e.g., not infecting other bacteria). Similar to other bacteriophage, cyanophage can alter metabolism and replication of its host, therefore manipulating the structure of the cyanobacterial community. If phage activation is initiated, reactions such as: selective lysis of target strains; decrease target population fitness by selecting for slower-growing phage-resistant bacteria that are more susceptible to biocides or to competitive exclusion; eradicating biofilms that typically protect the target bacteria; and supplementing or replacing antibiotics and biocides can occur. UV irradiation with optical dose and wavelength can induce phage activation and cause the phage to take a ‘lytic’ path of their host bacteria, resulting in bacterial cell death. It has been discovered, however, that the Microcystis infection with cyanophage can lead to cell death and that UV exposure induced lytic phase of the host Microcystis. It has been hypothesized that UV exposure suppressed (downregulated) the host's CRISPR-Cas system, thus allowing for enhanced the cyanophage's lytic activity.

### Unmanned Surface Vehicle

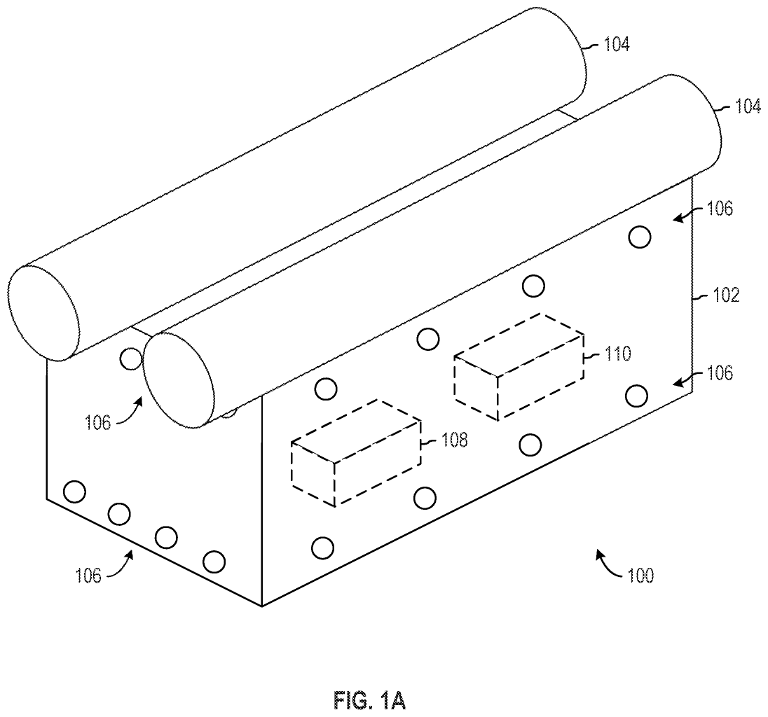

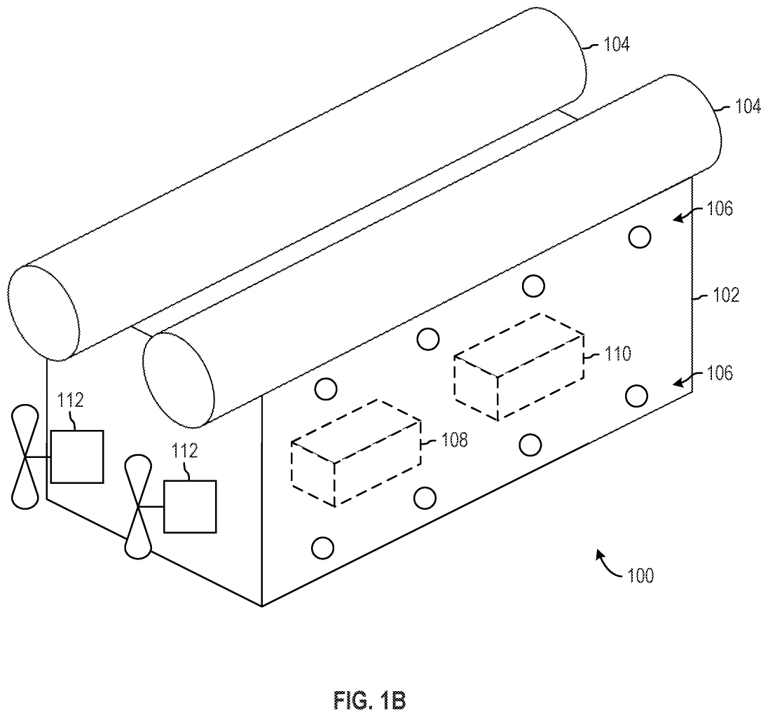

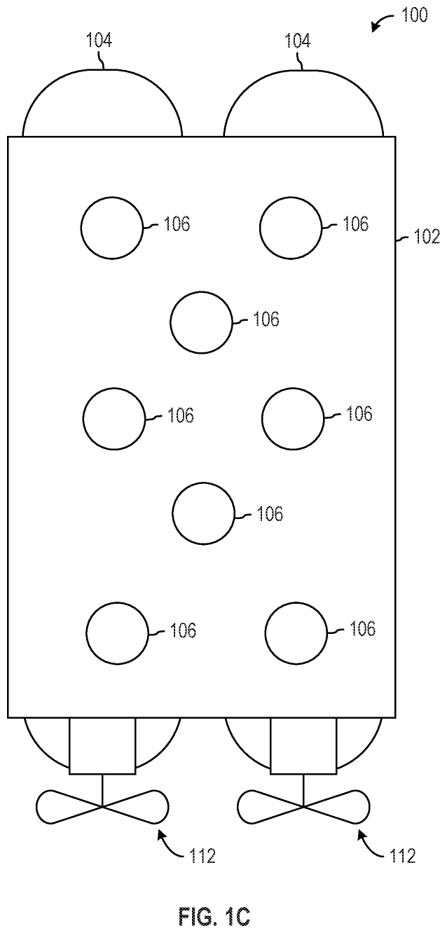

Turning first to FIGS. 1A-1C, diagrams illustrating an example configuration of unmanned surface vehicle (USV) 100 from various different perspectives are shown, according to some implementations. As briefly mentioned above, USV 100 may be configured for treating water treatment holding pools and inlet pipes to reduce Cyanobacteria and toxins. Generally, USV 100 is a drone or other type of water-borne vehicle that can operate on or near the surface of the water without an on-board operator. Accordingly, it will be appreciated that USV 100 may be used to treat water other than in water treatment holding pools. For example, USV 100 may be deployed in rivers, lakes, ponds, pools, etc., to reduce Cyanobacteria and toxins (e.g., by inactivating bacteria) and to treat other pathogens, such as E. coli, Salmonella, and the like.

Referring first to FIG. 1A, USV 100 is shown from a first perspective, in which the front, a first side, and the top of USV 100 are illustrated. As shown, USV 100 includes a frame assembly 102 to which a variety of components are coupled. Frame assembly 102 may be constructed of any suitable material, such as plastic, wood, vinyl, metal (e.g., aluminum), etc.; however, it should be appreciated that any materials used to construct USV 100 should be waterproof and corrosion resistant, as at least a portion of frame assembly 102 may be in contact with contaminated water. While generally referred to herein as frame assembly 102, it should also be appreciated that, in some implementations, frame assembly 102 is an enclosed housing. In other words, frame assembly 102 may include various frame members as well as side panels (not shown), and/or may be constructed from one or multiple pieces (e.g., a single, molded housing).

Mounted to a top side of frame assembly 102 (e.g., to a top frame portion) are one or more float tubes 104. Float tubes 104, also referred to as pontoons, are airtight, hollow structures that provide USV 100 with buoyancy in water. Accordingly, float tubes 104 may be constructed of any airtight material, such as plastic, metal, rubber, etc. In general, float tubes 104 may be filled with air, but may also be filled with other gases to improve buoyancy (e.g., helium, hydrogen, etc.). In the example shown, USV 100 includes two of float tubes 104. In other implementations, USV 100 may include fewer or more than two float tubes 104. Advantageously, USV 100 may be particularly small and light compared to other water treatment devices. For example, frame assembly 102 may be less than twelve (12) inches in length and less that six (6) inches wide. Additionally, USV 100 may weigh less than 6.5 pounds.

USV 100 is also shown to include a plurality of ultraviolet (UV) lights 106 which, in some cases, may be arranged in an array (e.g., including multiple UV lights 106). Generally, UV lights 106 operate (e.g., emit radiation or light) in the UV-C range, which is approximately 200 to 280 nm. UV-C radiation has been demonstrated to inactivate various bacteria, including Cyanobacteria, as described above. To this point, inactivating Cyanobacteria in water pools prevents the Cyanobacteria from reproducing and/or releasing harmful cyanotoxins. Unlike many other types of water treatment, treatment of Cyanobacteria and other pathogens using UV lights 106 does not require any harmful chemicals or produce any undesirable byproducts.

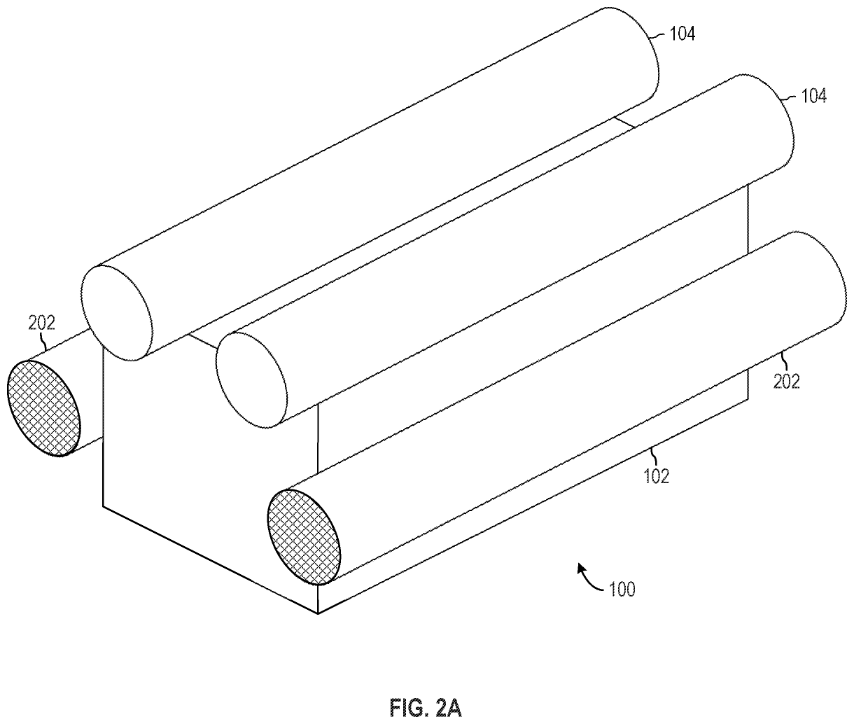

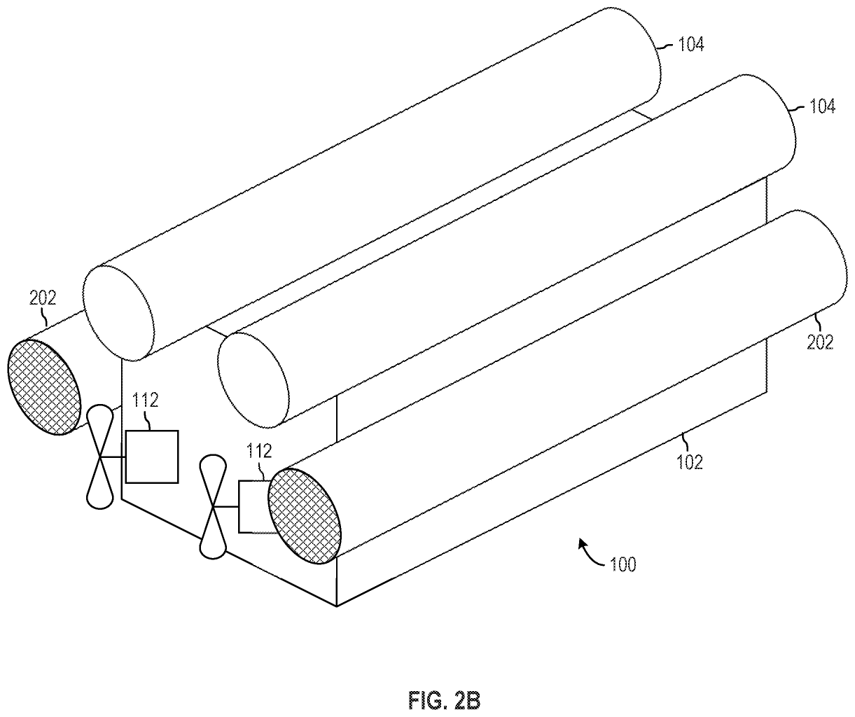

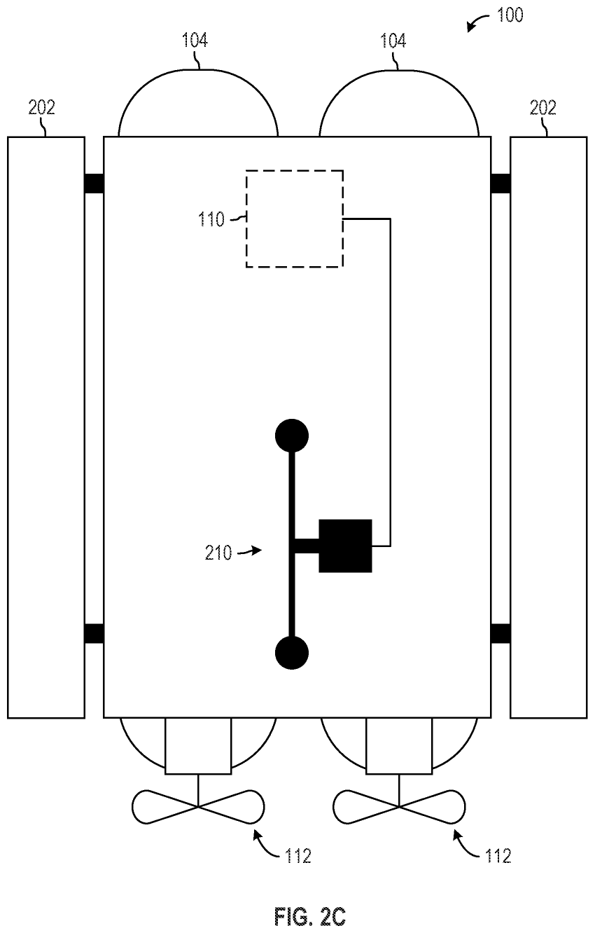

As described herein, UV lights 106 may be any suitable type of light for emitting UV radiation, including low-pressure mercury, pulsed xenon, excimer, etc., however, in some implementations, UV lights 106 are LEDs due to their small form factor, light weight, and energy efficiency. In particular, UV lights 106 may be UV-C LEDs that emit radiation (e.g., UV-C light) in the UV-C range of 100 nm to 280 nm. In some implementations, UV lights 106 are UV-C LEDs that emit radiation in the range of 250 to 280 nm. In some implementations, UV lights 106 emit radiation at 270 nm. In any case, UV lights 106 may be waterproof and/or may be covered by or enclosed in a waterproof housing. As shown, arrays of UV lights 106 may be positioned at the top and/or bottom portions each of side of USV 100. In particular, at least one array of UV lights 106 may be positioned on the top portion of each side of USV 100 to inactivate bacteria on the top layer of the water, as the top frame of frame assembly 102 sits at or just below the surface of the water due to the position float tubes 104. In general, UV lights 106 may emit UV-C radiation (i.e., light) to the sides of USV 100. In some implementations, an array of UV lights 106 is arranged within a hollow tube through which water flows for treatment, as further described below with respect to FIGS. 2A-2B.

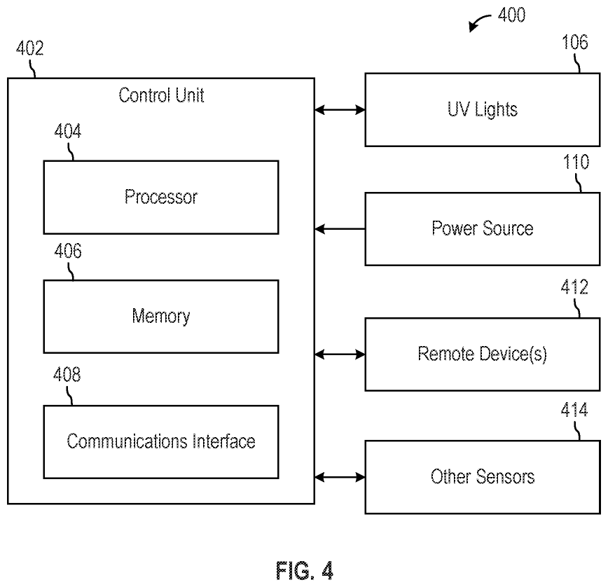

In some implementations, USV 100 also includes a controller 108 positioned on an interior of frame assembly 102. In some such implementations, controller 108 is contained within a waterproof housing. In other implementations, where frame assembly 102 includes side panels to form a watertight hull, controller 108 may be positioned within the watertight hull. In yet other implementations, controller 108 may be external to USV 100 (e.g., handle-held by a user) and is therefore not mounted to or positioned on USV 100; rather, controller 108 may be coupled to the various components of USV 100 via a suitable cable or cord. Controller 108 may include one or more processors and memory devices that store instructions. By executing the stored instructions using the one or more processors, controller 108 can control UV lights 106, such as by selectively activating UV lights 106 (e.g., turning UV lights 106 on/off). Additionally, controller 108 may operate one or more motors 112, which in turn rotate propellers to propel USV 100 through the water. Motors 112 are described in greater detail below with respect to FIG. 1B. Controller 108 is also described in greater detail below with respect to FIG. 4.

In some implementations, USV 100 further includes a power supply 110 configured to provide electrical energy to UV lights 106, controller 108, and/or motors 112. In some implementations, power supply 110 is a battery, such as a lithium battery, a nickel-cadmium battery, or the like. In some such implementations, power supply 110 is rechargeable or replaceable. In some implementations, power supply 110 is contained within a waterproof housing, which may be the same as or different from the waterproof housing used to contain controller 108. In some implementations, power supply 110 includes an on-board power converter or amplifier. In some implementations, power supply 110 is external to USV 110. In such implementation, USV 100 may be electrically coupled to power supply 110 via a wire, cable, tether, or the like. For example, power supply 110 may be coupled to USV 110 through a cable that is of sufficient length (e.g., >50 feet) to allow USV 100 to maneuver freely in a body of water. In some implementations, USV 100 includes a component or components capable of generating electricity to supplement power supply 110 or to recharge a battery of power supply 110. In some such implementations, USV 100 may include a solar panel (not shown) which is mounted to a top side of USV 100 (e.g., on top of float tubes 104) or a hydroelectric generator, as described in greater detail below. In some implementations, USV 100 may include a wind turbine (not shown) mounted to USV 100.

Referring now to FIG. 1B, USV 100 is shown from a second perspective, in which the rear, a second side, and the top of USV 100 are illustrated (e.g., in which USV 100 is rotated 180° from the first perspective shown in FIG. 1A). From this perspective, motors 112 are clearly shown to be directed to the rear of USV 100. In some implementations, USV 100 includes at least two motors 112, which may be independently controlled to allow USV 100 to maneuver (e.g., steer) through water. In other implementations, USV 100 may include only one motor 112 along with a corresponding rudder or fin that can be controlled to change the direction in which USV 100 is travelling. In any case, motors 112 may be electric motors that are driven by controller 108. In particular, controller 108 may provide energy and/or control signals to motors 112 to cause motors 112 to operate (e.g., by rotating). For example, controller 108 may transmit pulse width modulated (PWM) control signals to motors 112 to adjust the speed (i.e., rotational speed) of motors 112. As shown, each of motors 112 may include a propeller that, when rotated by a corresponding motor 112, moves USV 100 through the water. Motors 112 are preferably waterproof motors but may also be enclosed in a waterproof housing. In one example, motors 112 are able to displace in the range of 1,100 gallons of water per hour (GPH) and may consume about 3 amps.

In FIG. IC, USV 100 is shown from a third perspective (e.g., from a “bottom up” perspective). In particular, the bottom of USV 100 is shown to include an array of UV lights 106 that are configured to emit UV-C radiation downward from USV 100. In this manner, the array of UV lights 106 positioned on the bottom of USV 100 may inactivate bacteria below the surface of the water. While not shown, USV 100 may further include a variety of additional sensors positioned on the sides and/or bottom of frame assembly 102. In some implementations, USV 100 may include one or more cameras, Light Detection and Ranging (LiDAR) sensors, infrared sensors, visible lights (e.g., white or colored LED arrays), ultrasonic sensors, water quality sensors, and the like. For example, a camera and a LiDAR sensor may be positioned on the front of USV 100 to provide video feedback and/or to autonomously control USV 100.

Referring now to FIGS. 2A-2C, an alternate configuration of USV 100 is shown, according to some implementations. Generally, the configuration of USV 100 shown in these figures is the same as the configuration described above with respect to FIGS. 1A-1C; thus, not ever component shown in FIGS. 2A-2C is described herein. However, in the alternate configuration shown, USV 100 includes two UV-C tubes 202—one mounted to each side of USV 100—rather than an external array of UV lights 106. As described in greater detail below, UV-C tubes 202 are generally hollow and include, on an interior surface, an array of UV lights 106. Because UV-C tubes 202 are hollow, water can flow through the open interior space of UV-C tubes 202 and, in turn, can be irradiated by the emissions of UV lights 106.

It should be appreciated that any number of UV-C tubes 202 can be mounted to or otherwise positioned on USV 100. For example, while two UV-C tubes 202 are shown, USV 100 may include only one or more than two UV-C tubes 202, and UV-C tubes 202 may be mounted in other positions than on the sides of USV 100. Additionally, or alternatively, USV 100 may include UV lights 106 that are both coupled to frame assembly 102 and positioned within UV-C tubes 202.

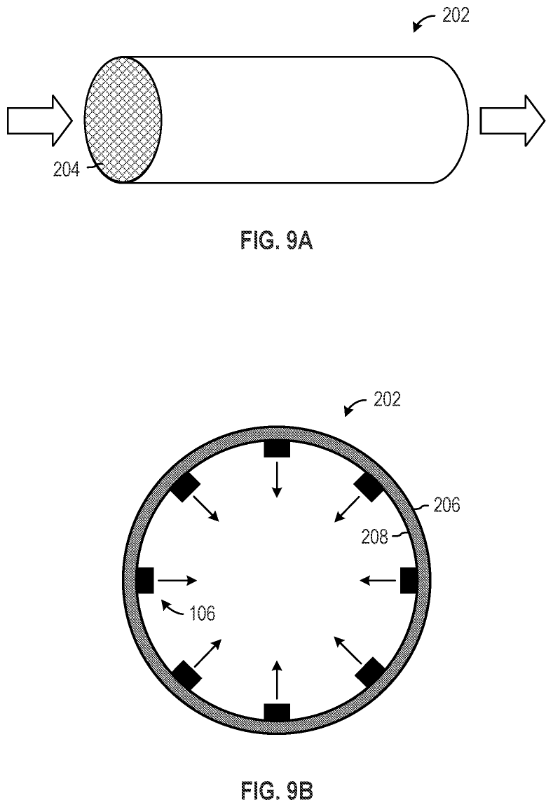

With additional reference to FIGS. 9A and 9B, an example UV-C tube 202 is shown in greater detail. As mentioned, UV-C tube 202 is generally a hollow, elongated tube defined by a side wall 206 formed of any suitable material, such as a plastic (e.g., PVC), metal, glass, or the like. Unlike float tubes 104, which are sealed to provide buoyancy, UV-C tube 202 has two open ends to allow water to pass therethrough. Specifically, UV-C tube 202 may be positioned such that water moves through UV-C tube 202 as USV 100 maneuvers. In some implementations, at least one end of UV-C tube 202—generally, the forward or front-facing end—includes a screen 204 or mesh to prevent debris from entering UV-C tube 202. For example, screen 204 may be sized to prevent leaves, twigs, insects, and other debris from passing through UV-C tube 202. In some implementations, both ends of UV-C tube 202 include screen 204. In the example of FIG. 9A, it is shown that dirty or untreated water passes through screen 204 then through the body of UV-C tube 202 where it is treated by UV lights 106. Treated or “clean” water then exits UV-C tube 202 through the second end.

As mentioned above, FIG. 9B shows that an interior surface of UV-C tube 202 has a plurality of UV lights 106 arranged thereon and positioned to emit light inward. Thus, as water passes through UV-C tube 202, it can be adequately irradiated by UV-C light. Notably, the use of UV-C tubes 202 can help to ensure that untreated water is sufficiently irradiate by increasing contact time with the UV-C light from UV lights 106 and decreasing the treatment distance, as it is known that UV-C effectiveness diminishes as increase from the UV-C source increases. In some implementations, the interior surface of UV-C tube 202 is coated with a titanium dioxide (TiO₂) layer 208, which can help to further increase the effectiveness of UV lights 106. Specifically, a nanoparticle coating of TiO₂ provides photocatalytic activity, thus enhancing Microcystin degradation efficiency with UV-C. UV illumination induces hydroxyl radicals (—OH) produced from the active electron and positive hole of TiO₂, which reacts with Microcystins. TiO₂ acts as a photosensitizer. The hydroxyl radicals generated can non-selectively oxidize a wide variety of refractory organic pollutants in water. Thus, the combination of UV-C radiation and TiO₂ treatment is time-and cost-effective, and environmentally sustainable. In addition, TiO₂ layer 208 can be at least partially reflective, which increases the effectiveness of UV-C light by reflecting emissions from UV lights 106 throughout UV-C tube 202.

Referring now to FIG. 2C, USV 100 is shown to include a hydroelectric turbine 210, in some implementations. Hydroelectric turbine 210 generally includes a turbine that is rotated by moving water (e.g., due to the motion of USV 100) to produce electricity, which is provided to power supply 110 for use in operating USV 100 and/or to recharge a battery of power supply 110. Accordingly, in some such implementations, power supply 110 may include a converter which transforms, for example, AC electricity produced by hydroelectric turbine 210 into DC for charging a battery and/or powering the various components of USV 100. In other implementations, hydroelectric turbine 210 includes a built-in converter. In some implementations, power supply 110 includes a charge controller or other components to monitor and control charging of a rechargeable power source. In some implementations, power supply 110 includes a microcontroller or other device for apportioning energy from hydroelectric turbine 210 and/or a battery.

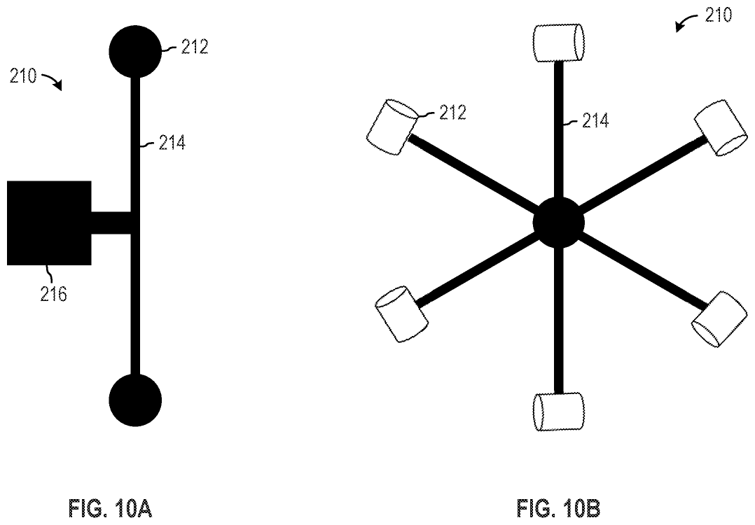

In any case, with additional reference to FIGS. 10A and 10B, hydroelectric turbine 210 is shown to include a plurality of cups or paddles—referred to herein as cups 212—which catch moving water to spin a generator 216. Each of cups 212 may be mounted to or positioned on a respective arm 214 which connects the cups to a central shaft of generator 216. Thus, the motion of USV 100 through the water can be used to at least partially power USV 100 by using the water moving past USV 100 to spin generator 216, thereby generating electricity. It should be appreciated, however, that the particular configuration of hydroelectric turbine 210 shown in FIGS. 10A and 10B is not intended to be limiting; rather, other configurations of hydroelectric generators could be mounted to or positioned on USV 100 to generate electricity from moving water. Additionally, or alternatively, USV 100 may include a top-mounted solar panel for generating electricity from sunlight.

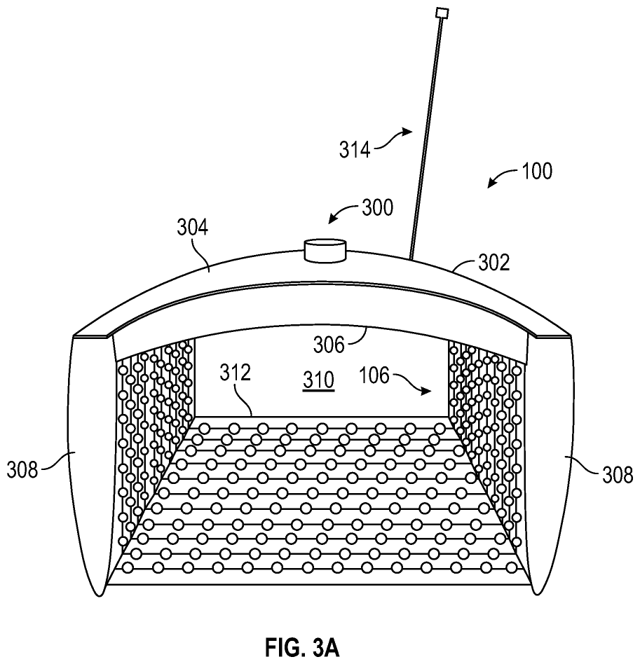

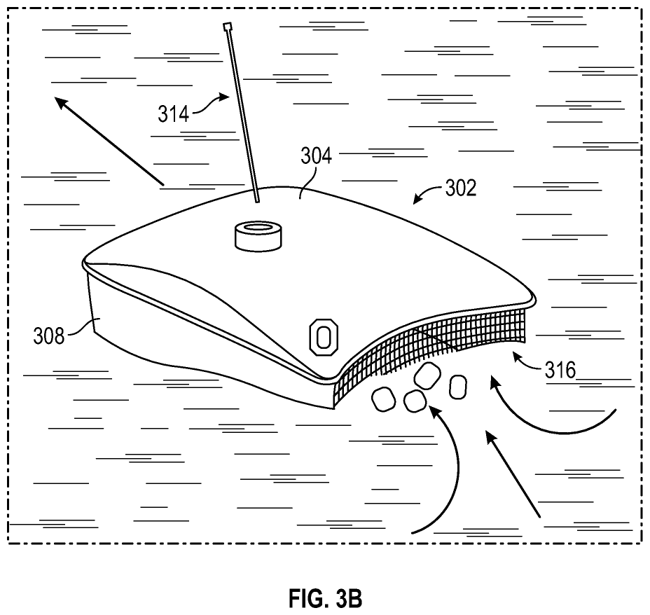

Referring now to FIGS. 3A and 3B, yet another example configuration of USV 100 is shown from various perspectives, according to some implementations. As shown, in this configuration, USV 100 includes a body 300 formed of a shell 302, defined by an upper shell portion 304 and a lower shell portion 306, and two parallel hull portions 308 that extend downward from the shell. As described herein, shell 302 and hull portions 308 may generally be formed or manufactured of any suitable material(s) for use in water. For example, shell 302 and/or hull portions 308 may be formed of a plastic, fiberglass, metal, or the like. In some implementations, shell 302 and hull portions 308 are formed of different materials. For example, shell 302 may be formed of a plastic while hull portions 308 are formed of a metal. In other implementations, shell 302 and bull portions 308 are integrally formed using the same material (e.g., fiberglass or plastic). In some implementations, USV 100 includes an internal frame assembly (not shown) form of a suitable material, similar to or the same as frame assembly 102 described above.

It should be noted that both shell 302 and hull portions 308 are generally watertight, as USV 100 is intended to be place in the water. In some implementations, shell 302 houses a controller (e.g., controller 108), a power supply (e.g., power supply 110), and other electronics, and thus is watertight to prevent these any other electronic components from getting wet. In some such implementations, upper and lower shell portions 304, 306 are integrally formed or are bonded using any suitable method for creating a watertight seal (e.g., adhesives, welding, etc.). While not illustrated in FIGS. 3A and 3B, it should be appreciated that USV 100 can also include a hydroelectric turbine (e.g., hydroelectric turbine 210), wind turbine, and/or solar panels for generating electricity; thus, water-sensitive portions of these power generating components may also be enclosed in shell 302. In some implementations, USV 100 can include a solar panel positioned on top of upper shell portion 304 and/or integrated with upper shell portion 304. For example, at least a portion of upper shell portion 304 may be a solar panel. In some implementations, USV 100 may include an antenna 314 that extends from upper shell portion 304 or another position on USV 100 to receive and/or transmit radiofrequency signals (e.g., from a controller). In some such implementations, antenna 314 can be contained within shell 302 and/or integrated into shell 302.

As shown, hull portions 308 generally extend downward from shell 302 and thus into the water when USV 100 is in use to provide buoyancy. This configuration is sometimes referred to as a “catamaran” or “multi-hull” configuration. In some implementations, hull portions 308 may be hollow or may be filled with a suitable material for providing or increasing buoyance (e.g., foam). In FIG. 3A, it is shown that hull portions 308 may have a shape that is similar to an airfoil. In other implementations, hull portions 308 may be shaped or configured as hydrofoils to lift shell 302 of USV 100 out of the water when in motion. However, it should be appreciated that hull portions 308 may generally be configured in any suitable shape and are not limited to the examples described herein. For example, hull portions 308 may be shaped as pontoons (e.g., hollow cylinders) similar to float tubes 104 described above. In any case, it should be appreciated that hull portions 308 are generally defined by an outer side that faces outward from and to the sides of USV 100 and an inner side that faces inward and towards a center of USV 100.

Together with lower shell portion 306, the inner sides of hull portions 308 generally form an open space 310 in USV 100. As shown in FIG. 3B, when USV 100 is in operation (e.g., when USV 100 is placed in the water), open space 310 may be at least partially filled with water. In other words, the lower sections of hull portions 308 may be submerged in water while upper sections of hull portions 308 and shell 302 remain out of the water. Thus, as USV 100 maneuvers, water passes under shell 302 and through open space 310 where it is illuminated by an array of UV lights 106. As shown in FIG. 3A, in particular, the array of UV lights 106 are generally positioned on the inner sides of inner sides of hull portions 308 such that, when activated, UV-C radiation (e.g., light) is emitted inward to open space 310. In some implementations, additional UV lights 106 may be positioned on lower shell portion 306 (not shown) to emit UV-C radiation downward into open space 310. In other words, in various implementations, one or both of the inner sides of hull portions 308 and lower shell portion 306 may contain one or more UV lights 106 to emit radiation into open space 310.

In some implementations, USV 100 further includes a bottom panel 312 that extends between and/or is coupled to hull portions 308. For example, in FIG. 3A, bottom panel 312 is shown to be coupled to and extending between the lower sections of hull portions 308. Thus, in some such implementations, open space 310 may be further defined by bottom panel 312. In some implementations, an additional array of UV lights 106 may be positioned on bottom panel 312 to emit UV-C radiation upward to open space 310. It should be appreciated that, in the configuration of FIGS. 3A and 3B, UV lights 106 may be positioned on a surface of the inner sides of hull portions 308, lower shell portion 306, and/or bottom panel 312, or may be otherwise integrated into said components of USV 100. For example, UV lights 106 may be waterproof or may be self-contained in a waterproof housing or, in cases where UV lights 106 are not waterproof, UV lights 106 may be encapsulated or integrated into hull portions 308, lower shell portion 306, and/or bottom panel 312 in such a way to prevent direct contact with water.

In some implementations (e.g., as shown in FIG. 3B), USV 100 includes a screen or mesh—herein referred to as screen 312—to filter any water entering open space 310. For example, screen 312 may be sized to prevent large particulate (e.g., wildlife, plant matter, trash, etc.) from entering open space 310. In some such implementations, screen 310 may positioned on a front side of USV 100. In some implementations, screen 310 extends between and/or is coupled to hull portions 308 at a front side of USV 100. In some implementations, an additional screen 310 can be included on a back side of USV 100 and therefore may extend between and/or be coupled to hull portions 308 at the back side of USV 100 (not shown).

### Controller

Referring now to FIG. 4, a diagram of a control system 400 for USV 100 is shown, according to some implementations. Control system 400 may include various components of USV 100 described above, including UV lights 106 and power supply 110. In addition, a control unit 402 is shown, which may be the same as, or functionally equivalent to, controller 108 described above. Accordingly, it should be appreciated that control system 400 and the various components thereof can be utilized and/or included in any of the configurations of USV 100 described herein. Control unit 402 is shown to include a processor 404 and memory 406. Processor 404 can be a general-purpose processor, an application specific integrated circuit (ASIC), one or more field programmable gate arrays (FPGAs), a group of processing components, or other suitable electronic processing components. In some implementations, processor 404 is configured to execute program code stored on memory 406 to cause control unit 402 to perform one or more operations.

Memory 406 can include one or more devices (e.g., memory units, memory devices, storage devices, etc.) for storing data and/or computer code for completing and/or facilitating the various processes described in the present disclosure. In some implementations, memory 406 includes tangible, computer-readable media that stores code or instructions executable by processor 404. Tangible, computer-readable media refers to any media that is capable of providing data that causes control unit 402 (i.e., a machine) to operate in a particular fashion. Example tangible, computer-readable media may include, but is not limited to, volatile media, non-volatile media, removable media and non-removable media implemented in any method or technology for storage of information such as computer readable instructions, data structures, program modules or other data.

Accordingly, memory 406 can include random access memory (RAM), read-only memory (ROM), hard drive storage, temporary storage, non-volatile memory, flash memory, optical memory, or any other suitable memory for storing software objects and/or computer instructions. Memory 406 can include database components, object code components, script components, or any other type of information structure for supporting the various activities and information structures described in the present disclosure. Memory 406 can be communicably connected to processor 404, such as via processing circuit (not shown), and can include computer code for executing (e.g., by processor 404) one or more processes described herein.

While shown as individual components, it will be appreciated that processor 404 and/or memory 406 can be implemented using a variety of different types and quantities of processors and memory. For example, processor 404 may represent a single processing device or multiple processing devices. Similarly, memory 406 may represent a single memory device or multiple memory devices. Additionally, in some implementations, control unit 402 may be implemented within a single computing device (e.g., one server, one housing, etc.). In other implementations control system 400 may be distributed across multiple servers or computers (e.g., that can exist in distributed locations). For example, control system 400 may include multiple distributed computing devices (e.g., multiple processors and/or memory devices) in communication with each other that collaborate to perform operations. For example, but not by way of limitation, an application may be partitioned in such a way as to permit concurrent and/or parallel processing of the instructions of the application.

Control unit 402 is also shown to include a communications interface 408. Communications interface 408 may facilitate communications between control unit 402 and any external components or devices. For example, communications interface 408 can provide means for transmitting data to, or receiving data from, remote device(s) 412. Accordingly, communications interface 408 can be or can include a wired or wireless communications interface (e.g., jacks, antennas, transmitters, receivers, transceivers, wire terminals, etc.) for conducting data communications. In various implementations, communications via communications interface 408 may be direct (e.g., local wired or wireless communications) or via a network (e.g., a WAN, the Internet, a cellular network, etc.).

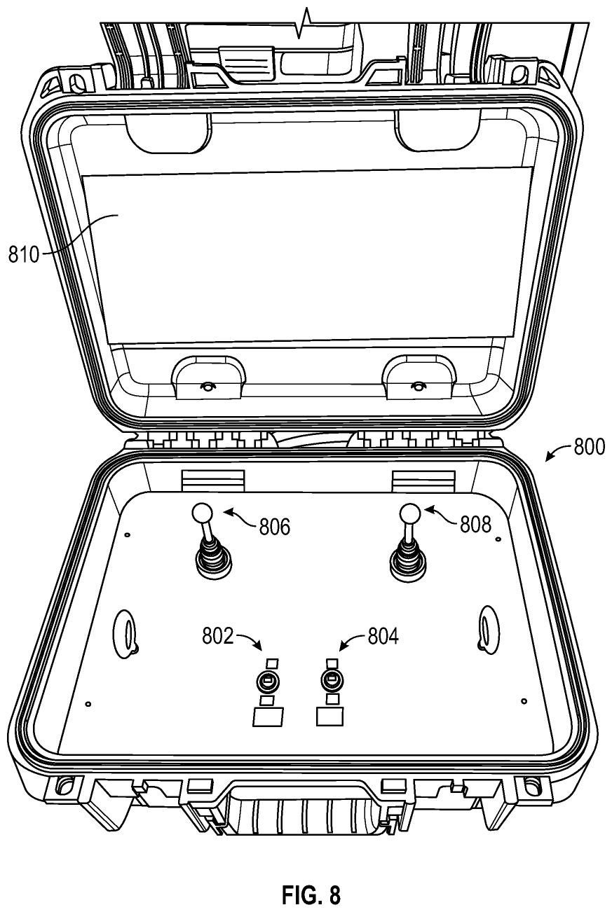

For example, communications interface 408 can include a WiFi® transceiver for communicating via a wireless communications network. In another example, communications interface 408 may include cellular or mobile phone communications transceivers. In yet another example, communications interface 408 may include a low-power or short-range wireless transceiver (e.g., Bluetooth®). In yet another example, communications interface 408 may be a direct, wired connection to one or more remote device(s) 412. In some implementations, remote device(s) 412 can include a wired or wireless controller (e.g., as shown in FIG. 8), a remote computing device (e.g., a smartphone, a laptop, a desktop, a smartwatch, etc.), a user interface, or the like. Thus, USV 100 could be operated by a remote controller via a suitable cable. In another example, USV 100 could be remotely operated using a smartphone, a laptop, a dedicated remote control, or the like which is wirelessly connected to control unit 402 via a wireless connection.

As shown, control unit 402 may control UV lights 106 by selectively activating (i.e., turning on and off) UV lights 106. For example, control unit 402 may control the power provided to UV lights 106 from power supply 110. In some implementations, control system 400 may include other sensors 414 for detecting a quality of water in which USV 100 is placed, which may be utilized by control unit 402 to control UV lights 106. Other sensors 414 may include a sensor or sensors (e.g., phycocyanin and/or chlorophyll sensors, blue green algae sensors, etc.) for detecting bacteria (e.g., Cyanobacteria) and pathogens in the water and, when bacteria are detected, or when the detected bacteria are above a threshold level, control unit 402 may activate UV lights 106. In other implementations, UV lights 106 may be manually activated by remote device(s) 412, which may include a remote control.

In some implementations, other sensors 414 can also include sensors that allow USV 100 to operate autonomously or semi-autonomously (e.g., without a human operator). For example, other sensors 414 can include one or more cameras, LiDAR sensors, infrared sensors, ultrasonic sensors, and the like. For example, a camera and a LiDAR sensor may be positioned on the front of USV 100. Accordingly, control unit 402 may receive data (e.g., images) from other sensors 414 which can be provided as an input to an object detection and/or recognition algorithm, such as a neural network or other machine learning algorithm. In some such implementations, control unit 402 may evaluate received images and/or other sensor data to detect objects and responsively generate or update a path or travel or trajectory. For example, control unit 402 may detect an object (e.g., a log) in the water and may manipulate motors 112 to steer around the object.

In some implementations, whether in an autonomous, semi-autonomous, or manual control configuration, control unit 402 may be configured to navigate USV 100 in a predefined pattern for treating an area of water. For example, USV 100 may traverse a grid pattern (e.g., in a 10 ft×10 ft area) such that each portion of the grid overlaps. In this manner, water in the treatment area may be in contact with UV lights 106 for an adequate amount of time to inactivate bacteria. In some implementations, the grid pattern traversed by USV 100 may be defined such that the light emitted by UV lights 106 contacts the water at various points of the treatment area for at least 60 seconds, to inactivate >90% of the bacteria in the water. In some implementations, a treatment area over which a grid may be defined can be identified using a drone, a camera, satellite imagery, or by any other suitable means for identifying concentrated HABs.

In some implementations, other sensors 414 include one or more gyroscopes, accelerometers, and/or magnetometers for detecting rate of rotation, angular velocity, tilt, linear movement, and direction (e.g., with respect to the magnetic field). In some such implementations, other sensors 414 can include an inertial measurement unit (IMU) that combines the functionality of gyroscopes, accelerometers, and/or magnetometers. In some implementations, other sensors 414 include a global positioning system (GPS) and/or global navigation satellite system (GNSS) transceiver for determining a location of USV 100 anywhere on Earth, which may be particularly useful when USV 100 is deployed to remote sites and/or is operating autonomously. In some implementations, other sensors 414 can include water speed sensors, multibeam sonar transceivers, thermal cameras, active radar deflectors, etc. In some implementations, other sensors 414 may include weather and/or environment detection sensors that measure wind speed, air speed, water temperature, etc. In other implementations, other sensors 414 may include a transceiver that allows USV 100 to communicate with a remote weather station.

### Example Configurations

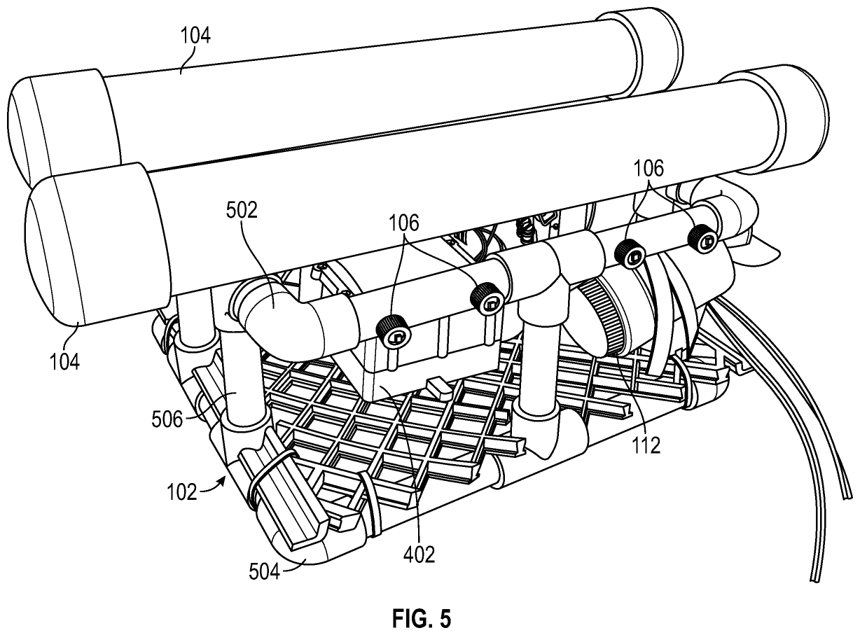

Referring generally to FIGS. 5-7, diagrams illustrating an example configuration of USV 100 are shown, according to some implementations. Turning first to FIG. 5, for example, an implementation of USV 100 is shown with an openly configured (e.g., without side panels) frame assembly 102. In this example, frame assembly 102 is shown to be formed of a top frame 402, a bottom frame 404, and one or more vertical supports 406 that couple top frame 402 and bottom frame 404. Additionally, in some implementations such as the one shown in FIG. 5, a bottom panel may be coupled to bottom frame 404 to which control unit 402, power supply 110 (not shown), motors 112, and/or UV-C tubes 202 (not shown) are coupled. Mounted to frame assembly 102 are a plurality of UV lights 106. As shown, UV lights 106 are mounted to top frame 402; however, it will be appreciated that, in other implementations, UV lights 106 may be positioned at various points on bottom frame 404 and/or the bottom of USV 100. In some implementations, UV lights 106 are positioned in UV-C tubes 202, described above, which can be mounted to any of top frame 402, bottom frame 404, vertical supports 406, or any side panels of USV 100 (not shown). In some implementations, although not shown, USV 100 may further include a catchment bag, vacuum system, or other components for collecting debris off the surface of the water.

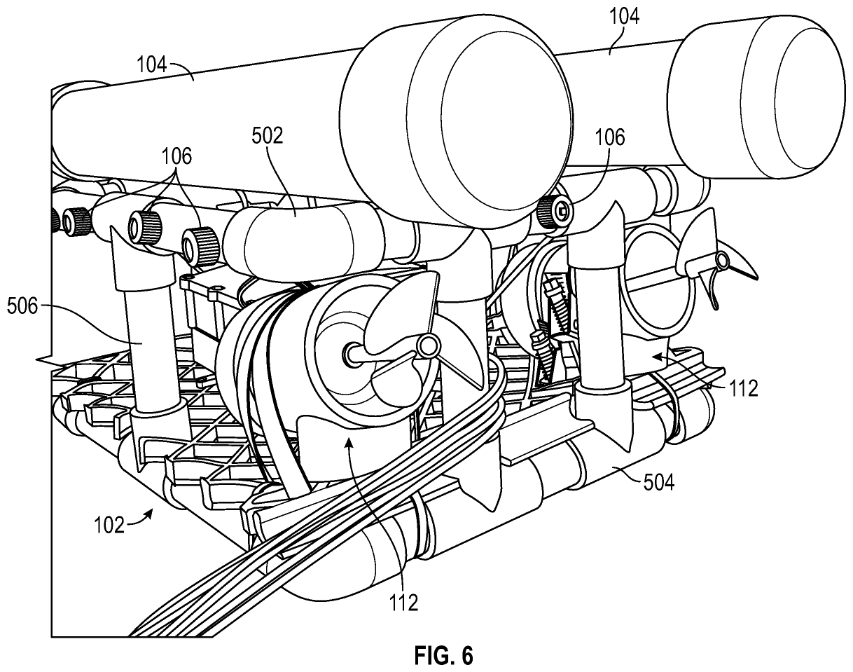

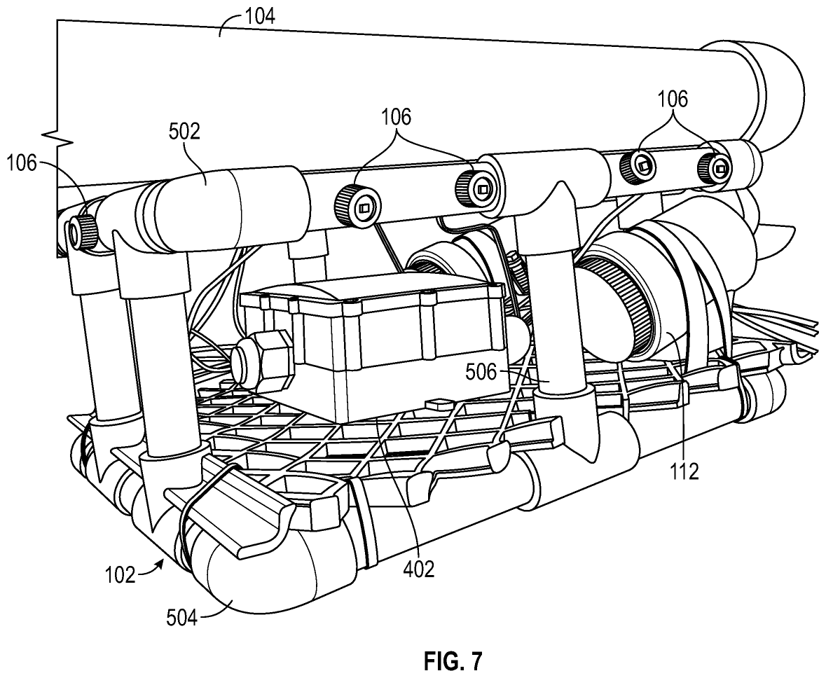

Referring now to FIG. 6, USV 100 is shown from another angle in which motors 112 are clearly visible. In this regard, motors 112 may be positioned to face the back of USV 100 and, in some implementations, may be mounted at an angle with respect to bottom frame 404. For example, motors 112 may be angled to point slightly upwards (e.g., toward the surface of the water) in order to keep UV lights 106 submerged just below the surface of the water. As also shown in FIG. 6, UV lights 106 may be positioned at any point of top frame 402, in some implementations. In this case, at least one UV light 106 is positioned on the back portion of top frame 402, between float tubes 104. These features of USV 100 are also shown in FIG. 7. However, as mentioned above, it should also be appreciated that UV lights 106 can be contained within UV-C tubes 202 mounted to USV 100.

Referring now to FIG. 8, a diagram of an example remote control 800 for USV 100 is shown, according to some implementations. As mentioned above, remote control 800 may be one of remote device(s) 412. For example, remote control 800 may be a component of control system 400 in implementations where USV 100 is at least partially operated by a human operator (e.g., semi-autonomous or manually controlled). Remote control 800 is shown a first switch 802 for providing power to USV 100 (e.g., by connecting or disconnecting power supply 110) and a second switch 804 for selectively activating UV lights 106. Additionally, remote control 800 includes a left joystick 806 and a right joystick 808 for independently controlling a left and right motor 112. For example, left joystick 806 may be pushed forward to cause the left motor 112 to accelerate (i.e., increase rotational speed). However, it will be appreciated that left and right joysticks 806, 808 may represent any type of input device (e.g., a mouse, a keyboard, a keypad, a touchscreen, etc.) that allows an operator to interact with USV 100. While not shown, remote control 800 may also include a display screen 810 (e.g., LCD, LED, touchscreen, etc.) for displaying images and data associated with USV 100. For example, display screen 810 may present a live camera feed from a camera mounted on USV 100 and/or may display live water quality information.

### Configuration of Certain Implementations

The construction and arrangement of the systems and methods as shown in the various exemplary implementations are illustrative only. Although only a few implementations have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative implementations. Other substitutions, modifications, changes, and omissions may be made in the design, operating conditions, and arrangement of the exemplary implementations without departing from the scope of the present disclosure.

The present disclosure contemplates methods, systems, and program products on any machine-readable media for accomplishing various operations. The implementations of the present disclosure may be implemented using existing computer processors, or by a special purpose computer processor for an appropriate system, incorporated for this or another purpose, or by a hardwired system. Implementations within the scope of the present disclosure include program products including machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor.

When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general-purpose computer, special purpose computer, or special purpose processing machines to perform a certain function or group of functions.

Although the figures show a specific order of method steps, the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

1. An unmanned surface vehicle (USV) for treating pathogens in a body of water, the USV comprising:
a frame assembly;
one or more motors coupled to the frame assembly, each of the one or more motors configured to drive a corresponding propeller;
one or more float tubes coupled to the frame assembly, wherein the one or more float tubes provide buoyancy such that the USV is configured to sit on or near a surface of the body of water;
a plurality of ultraviolet-C (UV-C) lights;
a controller configured to operate the one or more motors to cause the USV to maneuver on or near the surface of the body of water and to selectively activate the plurality of UV-C lights to inactivate pathogens in the body of water; and
a power supply to provide electrical power to the one or more motors, the plurality of UV-C lights and the controller

2. The USV of claim 1, further comprising one or more hollow UV-C tubes coupled to the frame assembly, wherein the plurality of UV-C lights are mounted to an interior surface of the one or more hollow UV-C tubes such that the plurality of UV-C lights are configured to emit radiation inward from the interior surface of the one or more hollow UV-C tubes.

3. The USV of claim 2, wherein each of the one or more hollow UV-C tubes is defined by a first end and a second end, wherein at least the first end comprises a screen or mesh.

4. (canceled)

5. The USV of claim 2, wherein the interior surface of the one or more hollow UV-C tubes is coated in titanium dioxide (TiO₂).

6. (canceled)

7. The USV of claim 1, wherein the frame assembly comprises a top frame portion, a bottom frame portion, and one or more supports that couple the top frame portion and the bottom frame portion, wherein the plurality of UV-C lights are positioned on at least one side of the top frame portion of the frame assembly and configured to emit radiation to at least one side of the USV.

8. (canceled)

9. (canceled)

10. (canceled)

11. The USV of claim 1, further comprising a hydroelectric turbine coupled to the frame assembly, wherein the hydroelectric turbine generates electricity due to movement of water as the USV to maneuvers on or near the surface of the body of water.

12. The USV of claim 11, wherein the hydroelectric turbine comprises:
a generator comprising a shaft;
a plurality of arms coupled to and extending from the shaft; and
a plurality of paddles or cups, wherein each of the plurality of paddles or cups is coupled to a respective one of the plurality of arms.

13. (canceled)

14. The USV of claim 1, wherein the controller comprises a wireless communications interface for wirelessly communicating data with a remote device.

15. (canceled)

16. (canceled)

17. (canceled)

18. (canceled)

19. The USV of claim 1, further comprising one or more sensors for monitoring water quality, wherein the controller is configured to automatically activate the plurality of UV-C lights if a level or amount of the detected pathogens exceeds a threshold.

20. (canceled)

21. The USV of claim 1, further comprising at least one of a gyroscope, an accelerometer, and a magnetometer.

22. (canceled)

23. (canceled)

24. An unmanned surface vehicle (USV) for treating pathogens in a body of water, the USV comprising:
a body comprising a shell and two parallel hull portions that extend downward from the shell, wherein the two parallel hull portions provide buoyancy such that the USV is configured to sit on or near a surface of the body of water;
one or more motors coupled to the frame assembly, each of the one or more motors configured to drive a corresponding propeller;
a plurality of ultraviolet-C (UV-C) lights;
a controller configured to operate the one or more motors to cause the USV to maneuver on or near the surface of the body of water and to selectively activate the plurality of UV-C lights to inactivate pathogens in the body of water; and
a power supply to provide electrical power to the one or more motors, the plurality of UV-C lights, and the controller.

25. (canceled)

26. The USV of claim 24, wherein the shell is defined by a top side and a bottom side, and wherein each of the two parallel hull portions are defined by an outer-facing side and an inner-facing side.

27. The USV of claim 26, wherein at least a portion of the plurality of UV-C lights are positioned on the bottom side of the shell to emit radiation downwards from the bottom side of the shell.

28. The USV of claim 26, wherein at least a portion of the plurality of UV-C lights are positioned on the inner-facing sides of the two parallel hull portions to emit radiation inwards.

29. The USV of claim 26, wherein the bottom side of the shell and the inner-facing sides of the two parallel hull portions define an open space below the shell of the USV.

30. The USV of claim 29, wherein the plurality of UV-C lights are positioned on the bottom side of the shell and on the inner-facing sides of the two parallel hull portions to emit radiation downwards and inwards into the open space.

31. The USV of claim 29, further comprising a panel coupled to a bottom of, and extending between, the two parallel hull portions, wherein at least a portion of the plurality of UV-C lights are coupled to a top surface of the panel and configured to emit radiation upward into the open space.

32. The USV of claim 24, wherein at least one of the bottom side of the shell or the inner-facing sides of the two parallel hull portions are coated in titanium dioxide (TiO₂).

33. (canceled)

34. (canceled

35. The USV of claim 24, further comprising a hydroelectric turbine coupled to the frame assembly, wherein the hydroelectric turbine generates electricity due to movement of water as the USV to maneuvers on or near the surface of the body of water.

36. The USV of claim 35, wherein the hydroelectric turbine comprises:
a generator comprising a shaft;
a plurality of arms coupled to and extending from the shaft; and
a plurality of paddles or cups, wherein each of the plurality of paddles or cups is coupled to a respective one of the plurality of arms.

37. (canceled)

38. The USV of claim 24, wherein the controller comprises a wireless communications interface for wirelessly communicating data with a remote device.

39. (canceled)

40. (canceled)

41. (canceled)

42. The USV of claim 24, further comprising one or more sensors for monitoring water quality, wherein the controller is configured to automatically activate the plurality of UV-C lights if a level or amount of the detected pathogens exceeds a threshold.

43. (canceled)

44. (canceled)

45. (canceled)

46. (canceled)
